(19) United States
(12) Patent Application Publication
(10) Pub. No.: US 2001/0028908 A1
(43) Pub. Date: Oct. 11, 2001

(54) Method and apparatus for producing equal -size round portions of dough

(76) Inventor: Max Schiessl, Grafelfing (DE)

Correspondence Address: BROWDY AND NEIMARK, P.L.L.C., 624 NINTH STREET, NW, SUITE 300, WASHINGTON, DC, 20001-5303, US

(21) Appl. No.: 09/793,899

(22) Filed: Feb. 28, 2001

(30) Foreign Application Priority Data
Feb. 29, 2000 (DE) 100 09 300.0

(51) Int. Cl. A21C 1/00

(52) U.S. Cl. 426/504; 366/69; 426/519

(57) ABSTRACT

In the shell of an incrementally rotatable drum (8) for producing equal-sized round portions of dough a train of portioning chambers (5) is accommodated arranged parallel to the drum centerline and continually variable in volume for filling from a main chamber (3) by means of a main piston with a dispensed nugget of dough. Arranged in the region of the bottommost inflection of the drum (8) is a molding device (10) executing an eccentric circulating movement from without so that the nuggets of dough introduced into the train of portioning chambers (5) are roundly molded into nearly spherical portions of dough (11) and centrally positioned in the portioning chamber. Preferably the molding movement is implemented as an eccentric circular movement in which, starting from a zero position, a maximum possible molding excursion is made before returning to the zero position.

### FIELD OF THE INVENTION

The invention relates to a method for producing equal-size round portions of dough as well as to an apparatus for implementing the method.

In a device for the continual production of round and/or angular portions of dough equal in volume or weight, dough is pressed from a hopper via a main chamber by means of a main piston into a train of portioning chambers arranged in the shell of a drum and each continuously variable in volume. In the production of round portions of dough the portions in the portioning chambers are worked round by a molding device executing an eccentric circular molding movement against the drum tangentially from without.

### BACKGROUND OF THE INVENTION

In devices of this kind, as are known, for example, from DE 29 43 088 C2, DE 28 53 270 C2, round-molding is done in a molding device by means of a molding plate in the region of the topmost inflection of the drum. In a device known from EP 0 449 840 B1 round-molding is done by a molding device having a molding belt in the topmost inflection of the drum. In a device as set forth in DE 29 49 562 C2 the portioning chambers are configured in a slide which is traveled vertically. Round-molding is done either with a molding plate arranged vertically upstream thereof or as in DE 31 23 200 A1 by a molding belt arranged vertically upstream thereof.

The disadvantage of these known apparatuses is that the portions of dough when worked are located in the portioning chambers and need to be pressed against the molding plate by the bottom of the portioning chamber being positioned adjustably towards the molding plate so that the friction between dough and molding plate is maintained; this is a mandatory requirement so that a near round ball of dough can form.

Furthermore, the portions of dough to be worked round are pushed to and fro relatively at random in the portioning chambers by a molding plate or molding belt in these known devices which fail to attain molding as achieved with a star-knived dough portioning and molding machine and considered to be ideal. Also more or less random is the finishing position or positioning of the portions of dough in the portioning chambers and the subsequent transfer of the round-molded portions of dough to downstream transport belts which has an unfavorable effect especially in continual further processing.

Common to all of the aforementioned devices or volumizers including portioning chambers is that the portioning chambers are arranged spaced away from each other by a relatively large spacing in the drum shell or on the slide surface because of the basic surface area of the portioning chambers usually being generally hexagonal or round, so that as regards the opening of the main chamber in relation to the portioning chambers in a drum or slide the interspaces between the portioning chambers form a large surface area against which the dough is pressed by the main piston in filling the portioning chambers and is thus squashed. This results in a very unfavorable change in the structure of the dough in later baking, i.e. the pore structure is more or less ruined to the detriment of the quality of the bakery products.

To offset these negative effects to a certain degree, more and expensive special baking additives are generally put to use. Apart from this, angular portions of dough cannot be produced by these known means due to the dough being unfavorably influenced in portioning, bearing comparison in quality to portions of dough as produced in a star-knived dough portioning and molding machine. It is likewise not possible with these known devices to work fat into the molding contact in producing so-called “Passauer” rose-type bread rolls as optimally as in a star-knived dough portioning and molding machine.

### SUMMARY OF THE INVENTION

It is thus the object of the invention to produce equal-sized round portions of dough so that the near round-molded portions of dough can be passed on defined in position to downstream conveying means. The invention is also intended to achieve that the dough is handled extremely gently as regards its structure when being filled into the portioning chambers.

In accordance with the invention this object is achieved by the steps in the method as set forth in claim 1 and by an apparatus having the features as set forth in the characterizing clause of claim 4. Advantageous aspects are the subject matter of the claims relating back to claim 1 or 4 directly or indirectly.

In accordance with the invention a dispensed nugget of dough is filled into each of a train of portioning chambers of an incrementally rotatable drum and the nuggets of dough in the individual portioning chambers are roundly molded into nearly spherical portions of dough by a molding movement implemented only in the region of the bottommost inflection of the drum.

In accordance with one preferred aspect of the invention the molding movement is implemented as an eccentric circular movement in which, starting from a zero position a maximum possible molding excursion is made before returning to the zero position. This results in the round-molded, nearly spherical portions of dough being positioned centrally in the middle of each portioning chamber to thus lie on and stick to the molding belt throughout the complete molding procedure, all in accordance with the invention.

In molding the portions of dough, an adjustable bottom of the portioning chambers located thereabove releases the space needed to form an ideal ball of dough in synchronism with the progressive molding movement without any disadvantageous pressure being exerted on the molded portions. It is in this way that nearly spherical portions of dough having a smooth surface and an optimum internal structure are produced, hitherto attainable only with a star-knived dough portioning and molding machine.

Since in accordance with the invention preferably an endless molding belt of a molding device is returned at the end of the molding procedure into its zero position, the nearly spherical portions of dough are always located centrally in the portioning chambers and have a precisely positioned molding contact downwards with the molding belt. This in turn is of particular advantage as regards a linear movement following the molding action in transferring the nearly spherical portions of dough to further processing stations.

In accordance with a preferred embodiment of the invention the endless molding belt may be configured as a molding or linked belt having a structured surface. Furthermore, any molding device can be swapped for another molding device whose molding belts are each structured differingly or feature smooth surfaces.

In accordance with yet another advantageous aspect of the invention each portioning chamber of the train thereof in the drum is continually adjustable in capacity or volume and has a rectangular, preferably square cross-section and a spacing of less than 6 mm. In accordance with another advantageous embodiment of the invention the walls between the individual portioning chambers and the walls opposite thereto of the two outer portioning chambers may be curved concave or convex.

Since the portioning chambers are filled with dough from a main chamber by means of a hydraulically, pneumatically or mechanically powered main piston whose urging pressure is continuously variable, the dough ejected from the main chamber by the main piston encounters practically no resistance, or an extremely low resistance, at the most, as compared to known designs hitherto, this being due to the advantageous configuration of the intermediate chamber walls, i.e. the walls between the portioning chambers. Thus, in accordance with the invention, it is especially in the region of the intermediate walls that the structure of the dough is maintained practically an optimum which has an extremely positive effect on the quality of the bakery products. Additionally, there is now no need for expensive special baking additives.

Furthermore, in accordance with the invention, a device for applying fat to the portions of dough located in the chambers may be provided, this device comprising a train of extensible plungers the same in number as the train of portioning chambers for fatting the surfaces or the inner parts of the portions of dough in the portioning chambers. The thus fatted portions of dough are then molded round so that a molding contact is formed which splits open ideally when baked.

To produce angled portions of dough the molding device can be taken out of circuit so that the apparatus in accordance with the invention can also be used to produce angled portions of dough in a quality which bears comparison to those as produced with a star-knived dough portioning and molding machine. When molding with or without fat or when portioning and producing angled portions of dough the known advantageous working action of a star-knived dough portioning and molding machine is thus simulated as best possible and can be realized in a continual working sequence.

Accordingly all doughs can be processed with the same processing variants as possible hitherto with a star-knived dough portioning and molding machine, the products obtained thereby excelling by a correspondingly excellent finished quality.

### BRIEF DESCRIPTION OF THE DRAWINGS

Preferred embodiments of the invention will now be detailed with reference to the drawings in which:

FIG. 1 is a diagrammatic illustration of the basic configuration of a preferred embodiment of an apparatus in accordance with the invention;

FIG. 2 is likewise a diagrammatic illustration of a further embodiment of the apparatus in accordance with the invention;

FIGS. 3a to 3c are diagrammatic plan views of an advantageous aspect of a train of portioning chambers, and

FIGS. 4a and 4b are diagrammatic plan views of hitherto usual shapes of a train of portioning chambers.

### DETAILED DESCRIPTION OF PREFERRED EMBODIMENTS

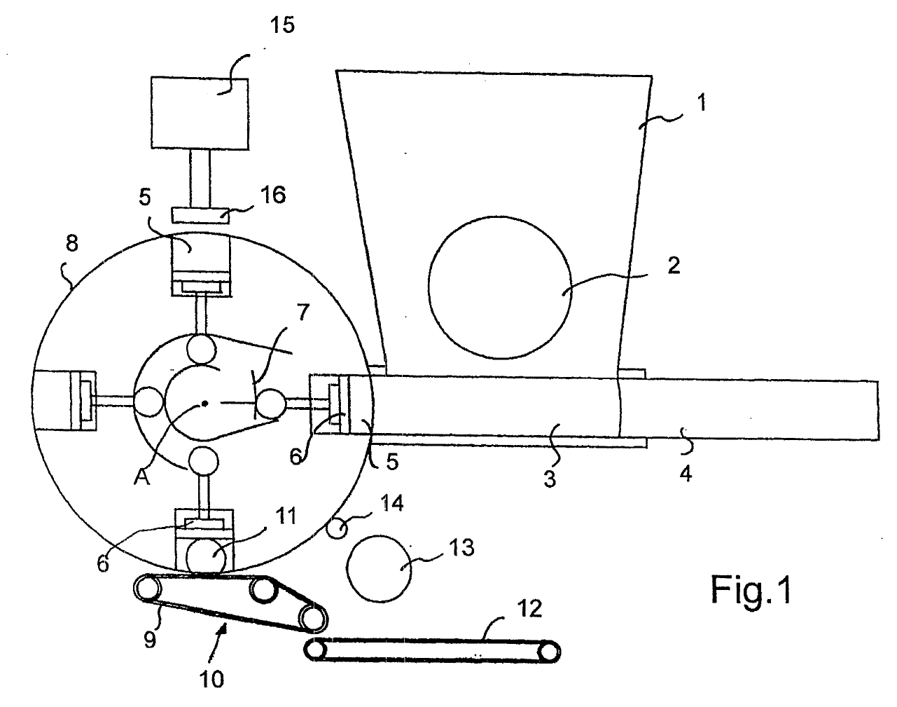

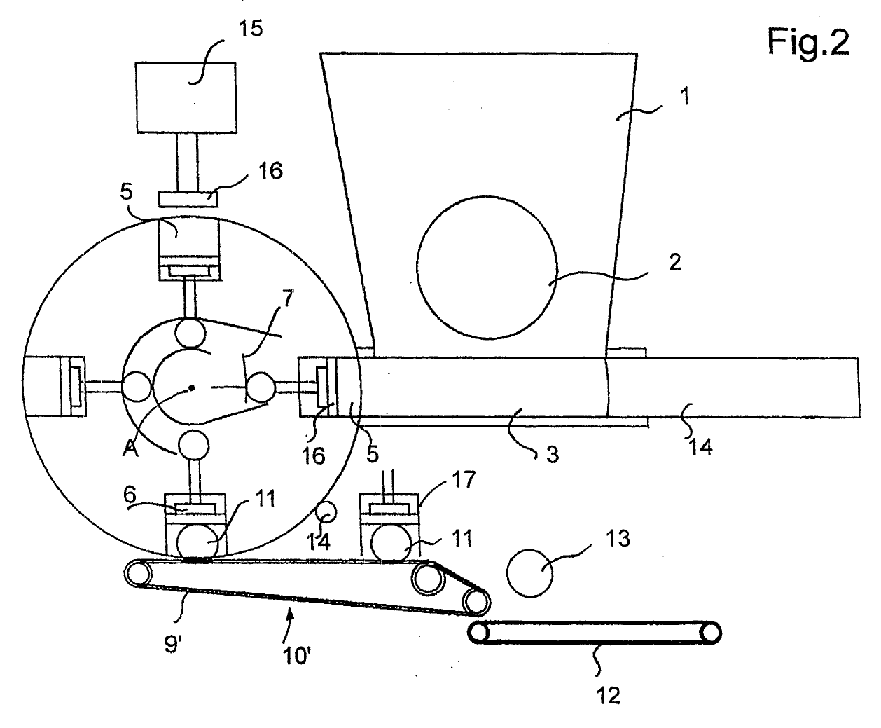

Referring now to FIG. 1 as well as to FIG. 2 there is illustrated an embodiment in which the dough (not shown) to be processed is fed via a hopper 1 in which a window 2 is provided to facilitate checking the level in the hopper 1. At the lower end of the hopper 1 as shown in FIGS. 1 and 2 a main chamber 3 is provided conically tapered in general in which a main piston 4, indicated diagrammatically, is arranged for linear movement in the direction of a drum 8, the main piston 4 including a drive (not shown) with which the driving force of the main piston 4 is continually varied by known ways and means.

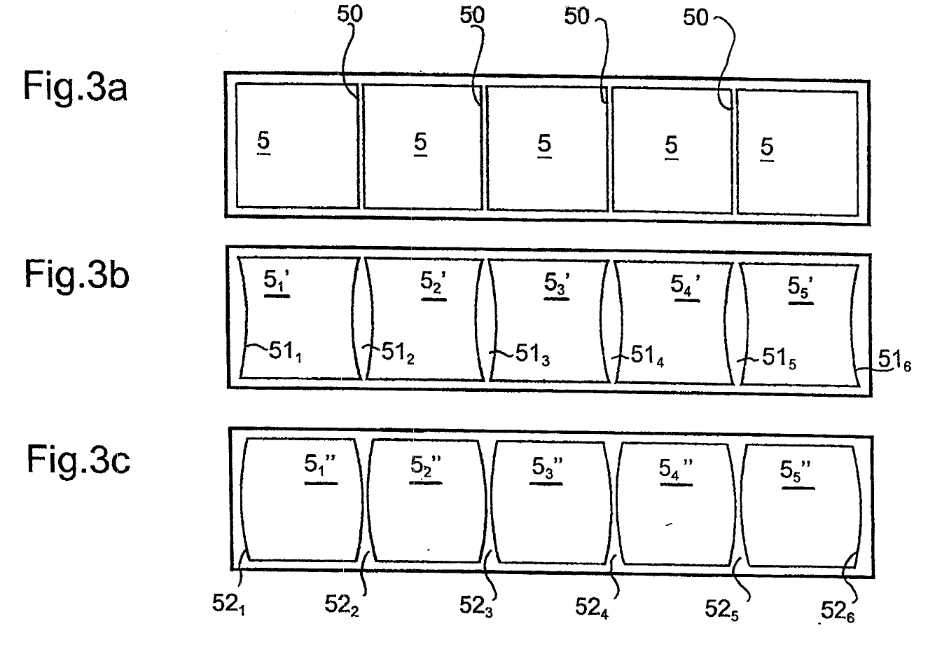

Accommodated in the shell of the drum 8 in the embodiment as shown in FIGS. 1 and 2 is a train of portioning chambers 5 arranged for example offset by 90° relative to each other, oriented parallel to a centerline A of the drum 8 indicated by a point in FIGS. 1 and 2. The special configuration of the portioning chambers 5 will be detailed later with reference to the FIGS. 3a to 3c. The volume of the individual portioning chambers 5 is continually varied by means of portioning chamber pistons 6 adjustably assigned to the chambers. For setting the volume of the individual portioning chambers 5 an end stop 7 is assigned to each portioning chamber.

To fill the train of portioning chambers 5 by means of the main piston 4 shown in its starting position in FIGS. 1 and 2, the dough accommodated in the main chamber 3 is urged into the portioning chambers 5, the capacity of which is continually varied by means of the portioning chamber pistons 6. The portioning chamber pistons 6 are urged by the nugget of dough pressed by the main piston 4 into the portioning chambers up to the corresponding set end stop 7. On attaining the preset compression pressure the drum 8 executes a working increment, i.e. it is turned through a further 90° in the functioning example as shown in FIGS. 1 and 2, resulting in the next train of empty portioning chambers 5 being positioned in front of the main chamber 3.

After two further increments, i.e. after being rotated by a total of 270° the train of portioning chambers 5 first filled with dough is at the bottommost inflection of the drum and facing downwards. The dough in each portioning chamber 5 is thereby urged by means of the variable portioning chamber pistons 6 downwards against a molding belt 9 located there. It is in this way that the nugget of dough in each of the portioning chambers 5 receives good friction contact with the molding belt 9 provided preferably with a structured surface.

At the same time as achieving this position in which the nugget of dough in the portioning chambers of a train of chambers is urged downwards against the molding belt a molding device 10 carrying the endless molding belt 9 is caused to execute an eccentric circular molding movement which is commenced in the zero position and once having attained the maximum possible molding excursion of the molding belt 9 is returned to the zero position. During this eccentric circular molding movement the portioning chamber pistons 6 are retracted in synchronism with the progressive molding movement into the portioning chambers 5 to thereby expose the molding space needed to work the nugget of dough in each portioning chamber into a nearly spherical portion of dough round so that an optimum nearly spherical molded portion can be formed.

On completion of the molding action, lasting but a few seconds, the drum 8 is rotated further at a peripheral speed corresponding to the linear advancement of the molding belt 9 commencing at the same time. With increasing counter-clockwise rotation of the drum 8 the portioning chamber pistons 6 are extended in the direction of the outer surface area of the drum until they have attained the outer surface area before the train of portioning chambers 5 has reached the filling position at the main chamber 3.

The nearly spherical molded portions 11 located on the molding belt 9 transporting them further are conveyed to a transfer belt 12, or as an alternative thereto to spreader belts (not shown). To ensure satisfactory transfer of the molded portions from the molding belt 9 to the transfer belt 12 or to the spreader belts a correspondingly adjustable and variable transfer roll 13 is arranged preferably in the transfer portion. So that the round-molded portions 11 are reliably released from the bottom of the portioning chambers 5 a sweeper roll 14 may be additionally arranged at the shell of the drum 8.

Provided preferably precisely diametrically opposite to the position in which the nuggets of dough located in the portioning chambers 5 are roundly molded into the nearly spherical molded portions 11 is a device 15 from which a train of plungers 16 corresponding to the train of portioning chambers can be extended and urged against the nugget of dough located in each portioning chamber 5. If this is the case fat is pressed from the individual plungers 16 surfacewise on and/or into the individual portions of dough located in the individual chambers.

Referring now to FIG. 2 there is illustrated diagrammatically an embodiment of the apparatus in accordance with the invention which unlike the embodiment as shown in FIG. 1 comprises a longer molding device 10′ and thus also a correspondingly longer endless molding belt 9′. In addition a further molding station 17 is provided which is lifted and lowered in time with the linear advancement of the longer molding belt 9 so that each of the train of dough portions 11 located on the molding belt 9 is conveyed into the molding station 17.

In the second molding station 17 the molding action is completed when the nuggets of dough molded only partly round in the first molding station arranged more to the left in FIG. 2 are produced into finished round-molded and thus nearly spherical portions of dough, as a result of which the time needed for molding is shared for example by two molding stations and is thus roughly halved in all to thus enable the hourly output of the apparatus to be correspondingly boosted.

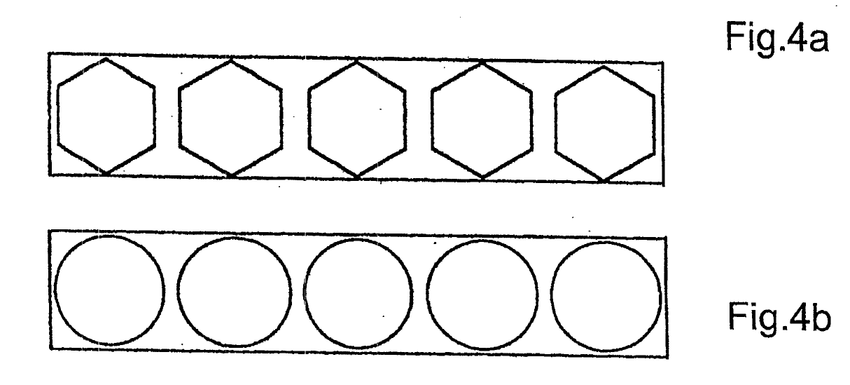

Referring now to FIGS. 4a and 4b there is illustrated in a diagrammatic plan view a train of, for example, five portioning chambers whose basic surface areas have the shape of a circle or an equal-sided hexagon. Relative to the opening of a main chamber, for example that of the main chamber 3, as compared to the surface area of the train of, for example, five portioning chambers the intermediate portions between, above and below the round or hexagonal portioning chambers represent a comparatively large surface area against which the dough is pressed and thus squashed by the main piston in filling these portioning chambers.

Referring now to FIG. 3a there is illustrated contrary thereto how in the case of the square portioning chambers 5, i.e. the portioning chambers 5 having a square basic surface area the portions between the, for example, five portioning chambers 5₁ to 5₅ are configured preferably as narrow intermediate chamber walls 50₂ to 50₅ whose wall thickness may be, for example, in the range of 2 to 2.5 mm. Thus as evident from the plan view as shown in FIG. 3a a highly favorable ratio of the surfaces of the intermediate chamber walls 50, i.e. the surface areas between the square portioning chambers 5 to the surface area of the opening of the main chamber 3 materializes.

For a side length of, for example, 60 mm of the square basic surface areas of the portioning chambers 5 this ratio is 1:29.8. Where circular portioning chambers having a diameter of 60 mm are concerned, a ratio of the surface of the intermediate portions between the round portioning chambers to the surface area of the main chamber opening of 1:4.2 materializes whilst in the case of portioning chambers having a hexagonal basic surface area the corresponding ratio is 1:3.6. This makes it obvious how low the resistance is as acting on the dough when filling square portioning chambers, or, in other words, how well the dough structure is maintained when filling square portioning chambers.

Referring now to FIG. 3b there is illustrated how, here too, the dough structure is maintained practically totally when the portioning chambers 51₂ to 51₅ configured between, for example, five portioning chambers 5₁′ to 5₅′ and the portioning chambers 51₁ and portioning chambers 51₆ of the two outer portioning chambers 5₁′ and 5₆′ opposite thereto are curved concave. Similarly good results are obtained as with square portioning chambers 5 when intermediate chamber walls 52₂ to 52₅ and the opposite walls 52₁ and 52₆ of the two outer portioning chambers 5₁″ and 5₆″0 are curved convex. In both cases the structure of the nuggets of dough urged by means of the molding belt 9 into the portioning chambers is maintained substantially or detrimented, at the most, only very slightly.

What is claimed is:

1. A method of producing equal-sized round portions of dough comprising the steps:
filling a dispensed nugget of dough into each portioning chamber of a train of portioning chambers of an incrementally rotated drum and
roundly molding the nuggets of dough introduced into each portioning chamber of a train from without into nearly spherical portions of dough by a molding movement implemented only in the region of the bottommost inflection of the drum.

2. The method as set forth in claim 1 wherein said nuggets of dough introduced into each of a train of portioning chambers are roundly molded by a molding movement implemented from without only in the region of the bottommost inflection of the drum as an eccentric circular movement in which, starting from a zero position a maximum possible molding excursion is made before returning to the zero position, into nearly spherical portions of dough simultaneously positioned centrally in the middle of each portioning chamber.

3. The method as set forth in claim 1 or 2 wherein after implementing a molding action in which said nuggets of dough introduced into said portioning chambers have been molded round said round-molded portions of dough are transferred by a linear advancement in synchronism with the peripheral speed of said drum.

4. An apparatus for producing equal-sized round portions of dough including an incrementally rotatable drum (8) in the shell of which a train of portioning chambers (5) arranged parallel to the drum centerline and continually varied in volume is accommodated for filling from a main chamber (3) by means of a hydraulically, pneumatically or mechanically powered main piston at a continuously variable compression pressure with a dispensed nugget of dough and including a molding device executing an eccentric circulating movement from without wherein said molding device (10) is arranged in the region of the bottommost inflection of said drum (8) outside of the latter so that said nuggets of dough introduced into each portioning chamber of a train thereof are roundly molded into nearly spherical portions of dough (11).

5. The apparatus as set forth in claim 4 wherein said molding device (10) comprises an endless molding belt (9) and is arranged outside of said drum (8) in the region of said bottommost inflection thereof so that said nuggets of dough introduced into said train of portioning chambers (S) are roundly molded into nearly spherical portions of dough and positioned centrally in the middle of each portioning chamber by an eccentric circular molding movement generated by means of said molding device (10) in which said molding belt (9) starting from a zero position returns via a maximum possible molding excursion into said zero position.

6. The apparatus as set forth in claim 5 wherein said endless molding belt (9) executes on completion of said molding action a corresponding linear advancement in synchronism with the peripheral speed of said incrementally further rotated drum (8).

7. The apparatus as set forth in claim 5 or 6 wherein said molding belt (9) is designed as an endless molding or linked belt having a structured surface and is driven so that starting from a zero position it returns via a maximum possible molding excursion into said zero position.

8. The apparatus as set forth in any of the claims 4 to 7 wherein said molding device (10) can be swapped for other molding devices having the same function, whose endless molding belts are differingly structured or also comprise smooth surfaces.

9. The apparatus as set forth in any of the claims 4 to 8 wherein one or more further molding stations (17) are arranged suitably spaced away from said bottommost inflection of said drum (8) where a longer molding device (10′) is concerned.

10. The apparatus as set forth in any of the claims 4 to 9 wherein each portioning chamber (5) of the train thereof in said drum (8) is continually adjustable in volume and has a rectangular cross-section and a spacing of less than 6 mm.

11. The apparatus as set forth in claim 10 wherein said portioning chambers (5) have a square cross-section.

12. The apparatus as set forth in claim 10 or 11 wherein the walls (51₂ to 51₅) between said individual portioning chambers (5₁′ to 5₅′) and the walls (52₁, 52₆) opposite thereto of the two outer portioning chambers (5₁″, 5₅″) are curved concave.

13. The apparatus as set forth in claim 10 or 11 wherein the walls (52₂ to 52₅) between said individual portioning chambers (5₁″ to 5₅″) and the walls (52₁, 52₆) opposite thereto of the two outer portioning chambers (5₁41 , 5₅″) are curved convex.

14. The apparatus as set forth in claim 4 or 5 wherein a device (15) for fatting said nuggets of dough located in said train of portioning chambers (5;5′;5″) comprises extensible plungers (16) adapted in size to said portioning chambers (5;5′;5″) by means of which fat emerging from said plungers (16) is urged on and/or in said nuggets of dough in said portioning chambers (5;5′;5″).
